(19) United States
(12) Patent Application Publication
(10) Pub. No.: US 2023/0009962 A1
(43) Pub. Date: Jan. 12, 2023

(54) NFC Antenna Structure for Radiation Enhancement

(71) Applicant: Google LLC, Mountain View, CA (US)

(72) Inventors: Che-Ting Yeh, New Taipei City (TW); Wei-Yang Wu, New Taipei City (TW); Hung-Chi Chiu, New Taipei City (TW)

(73) Assignee: Google LLC, Mountain View, CA (US)

(21) Appl. No.: 17/375,504

(22) Filed: Jul. 14, 2021

Related U.S. Application Data
(60) Provisional application No. 63/219,082, filed on Jul. 7, 2021.

(51) Int. Cl. H01Q 1/22; H01Q 7/06; H02J 7/02; H02J 50/10; G06F 1/16

(52) U.S. Cl. CPC H01Q 1/2258; H01Q 7/06; H02J 7/02; H02J 50/10; G06F 1/1613

(57) ABSTRACT

A near-field communication (NFC) antenna structure for radiation enhancement of a computing device that includes a ferrite sheet, separated into two sections. The NFC antenna structure may be used to improve (i) the magnetic field strength generated by an NFC antenna and (ii) inductive coupling to a receiving antenna of another computing device. A first ferrite section may be placed on a first side of the NFC antenna to at least partially overlap the NFC antenna, and a second ferrite section may be placed on a second side (opposite the first side) to at least partially overlap the NFC antenna. The first ferrite section may be positioned towards a top end that is often positioned closest to a receiving device, as held by a user when performing a contactless communication of the computing device, to increase the magnetic field strength and improve the inductive coupling at the top end.

### CROSS-REFERENCE TO RELATED MATTER

The present application claims priority to U.S. Provisional Application Ser. No. 63/219,082, filed Jul. 7, 2021, the entire disclosure of which is hereby incorporated by reference.

### SUMMARY

This disclosure describes a near-field communication (NFC) antenna structure for radiation enhancement of a computing device (e.g., a smartphone). The NFC antenna structure may include a ferrite sheet, separated into two sections, used to (i) increase the magnetic field strength generated by an NFC antenna of the NFC antenna structure and (ii) improve the inductive coupling to a receiving antenna of another computing device (e.g., a contactless payment device). A first ferrite section may be placed on a first side of the NFC antenna to at least partially cover the first side of the NFC antenna. A second ferrite section may be placed on a second side (opposite the first side) to at least partially cover the second side of the NFC antenna. The NFC antenna structure may also include a secondary coil (e.g., a wireless charging (WLC) coil) that overlaps the NFC antenna on the second side without overlapping the second ferrite section. The first ferrite section may be positioned towards a top end (e.g., an end positioned closest to a receiving device as held by a user when performing a contactless communication) of the computing device to increase the magnetic field strength and improve the inductive coupling at the top end.

Aspects described below include an NFC antenna structure for radiation enhancement of a computing device. The computing device may include a housing that substantially defines a housing plane. The housing may include a top end that defines a top plane, perpendicular to the housing plane, which is opposite a bottom end that defines a bottom plane, parallel to the top plane. The computing device may also include a primary coil comprising windings forming a first shape that is positioned substantially parallel to the housing plane and at least partially within the housing. The first shape may include a first side aligned parallel to the housing plane that is opposite a second side. The primary coil may be used to generate a magnetic field when subject to an electric current. The computing device may additionally include a secondary coil comprising windings forming a second shape that is positioned substantially parallel to the housing plane and at least partially within the housing. The secondary coil may at least partially overlap the primary coil in a direction that is normal to the housing plane on the second side to enable a portion of the magnetic field generated by the primary coil to be induced into the secondary coil through mutual induction. The computing device may further include a ferrite sheet configured to increase a strength of the magnetic field generated using the primary coil. The ferrite sheet may be separated into a first ferrite section and a second ferrite section. The first ferrite section may be positioned towards the top plane of the top end and at least partially within the housing. The first ferrite section may at least partially overlap the primary coil in the direction that is normal to the housing plane. The first ferrite section may be configured to overlap a first portion of the primary coil on the first side. The second ferrite section may be separate from the first ferrite section and positioned not to overlap the first ferrite section and not to overlap the secondary coil in the direction that is normal to the housing plane. The second ferrite section may be configured to overlap a second portion of the primary coil on the second side.

### BRIEF DESCRIPTION OF DRAWINGS

An NFC antenna structure for radiation enhancement of a computing device is described with reference to the following drawings. The same numbers are used throughout the drawings to reference like features and components:

FIG. 1 illustrates example implementations of a computing device used to perform a contactless communication with a receiving computing device;

FIG. 2-1 illustrates an example environment of a computing device that includes a primary coil configured as an NFC antenna;

FIG. 2-2 illustrates example cross-sectional views of the NFC antenna structure that depict the ferrite sheet separated into two sections;

FIG. 3 illustrates example, non-limiting, variations of the NFC antenna structure; and

FIGS. 4-1 and 4-2 illustrate example implementations of the NFC antenna structure to increase the magnetic field strength generated by the NFC antenna and improve the inductive coupling to a receiving antenna.

### DETAILED DESCRIPTION

### Contactless Communication Using NFC Antennas

An NFC antenna may be used by a computing device to communicate with another computing device over a short distance (e.g., a distance less than 4 centimeters (cm)) without contact. The computing device may provide a current to the NFC antenna to generate radiation that may be at least partially received by a receiving NFC antenna of another computing device. For example, a smartphone may transfer payment information to an electronic reader by sending an alternating current to an NFC antenna of the smartphone to generate magnetic fields. When the smartphone is positioned near the electronic reader, changes in the magnetic flux (e.g., associated with the generated magnetic fields) over time may induce a current into a receiving NFC antenna of the electronic reader through inductive coupling to transfer the payment information.

To improve performance of contactless communications using NFC antennas, some manufacturers include one or more ferrite sheets, comprising a ferrimagnetic material, in an NFC antenna structure to localize magnetic fields and reduce magnetic-field loss. These ferrite sheets may also act as an insulator to protect circuitry of the computing device. Some manufacturers also improve performance of contactless communications by inducing magnetic fields into a parasitic resonator (e.g., a WLC coil) of the computing device, positioned near the NFC antenna, to increase the magnetic field strength of the structure.

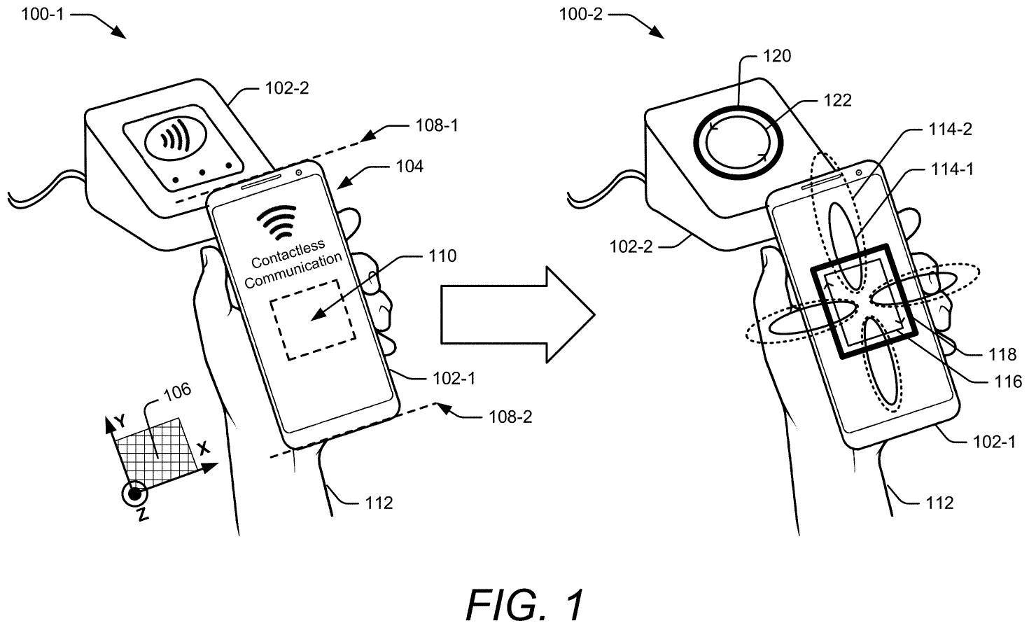

FIG. 1 illustrates example implementations 100 of a computing device 102-1 used to perform a contactless communication with a receiving computing device 102-2. The computing device 102-1 may include a housing 104 that at least partially covers (e.g., encloses, protects) an NFC antenna structure and substantially defines a housing plane 106 (e.g., an XY plane). The housing 104 may include a top end 108-1 that defines a top plane (e.g., an XZ plane) perpendicular to the housing plane 106. The top end 108-1 may be opposite a bottom end 108-2 that defines a bottom plane (e.g., another XZ plane) parallel to the top plane. The housing 104 may include one or more durable materials such as plastic, metal, rubber, composite material, and so forth. The housing 104 may also include one or more opaque, semi-transparent, and/or transparent materials.

Example implementation 100-1 illustrates that a user 112 may orient the top end 108-1 of their computing device 102-1 near the receiving computing device 102-2 to comfortably perform a contactless communication. To do so, the user 112 may grip the computing device 102-1 in a manner that leaves the display screen mostly unobscured by the user's hand but may at least partially overlap a center region 110 on the backside of the computing device 102-1.

Example implementation 100-2 illustrates the computing device 102-1 being positioned near a receiving computing device 102-2 and generating magnetic fields 114-1 when a current 116 is supplied to an NFC antenna 118. Changes in the magnetic flux over time, associated with these magnetic fields 114-1, may induce an electromotive force (EMF) into a receiving antenna 120 in accordance with Faraday's law of induction. This EMF may correspond to an induced current 122 associated with, for instance, encrypted information used to complete a contactless payment.

Some conventional NFC antenna structures, however, may generate magnetic fields 114-1 with a peak strength near the center region 110 of the computing device 102-1. As a result, the user 112 may be required to orient the center region 110 of the computing device 102-1 closer to the receiving computing device 102-2, which may be less comfortable and/or require a less natural grip of their hand. Consequently, barriers may exist that prevent users from efficiently performing a contactless communication using an NFC antenna of a computing device.

This disclosure describes an NFC antenna structure that utilizes a ferrite sheet configuration to (i) increase the strength of magnetic fields 114-2 generated by an NFC antenna and (ii) improve the inductive coupling to a receiving device. Furthermore, this NFC antenna structure may increase the magnetic-field strength 114-2 and improve the inductive coupling towards the top end 108-1 of a computing device 102 to enable users to comfortably perform contactless communications.

While the computing device 102-1 depicted in FIG. 1 is a smartphone, other types of computing devices may also support the techniques described herein. A computing device 102 may include, for instance, a tablet, a laptop, a computing watch, computing glasses, a home-service device, a drone, a netbook, an e-reader, a virtual-reality headset, and/or another home appliance. The computing device 102 may be wearable or non-wearable but mobile. The computing device 102 may include one or more processors, receivers, transmitters, circuitry, and so forth.

In general, an NFC antenna may refer to an electromagnetic coil comprising a conductive material (e.g., copper) that enables the flow of current at a resonant frequency, for instance, of 13.56 Megahertz (MHz). The electrical characteristics of the NFC antenna may include an inductance, a resistance, and a capacitance based on an associated topography (e.g., dimensions, number of windings, spacing). For example, some NFC antennas are configured for an inductance of 200-600 nanohenry (nH) with a quality factor of approximately 8-15 and a self-resonant frequency greater than 30 MHz. NFC antennas may be used to read and/or write information on NFC tags, communicate with another NFC antenna of a second device, and/or perform card emulation for transactions including payments or ticketing.

### Example NFC Antenna Structure

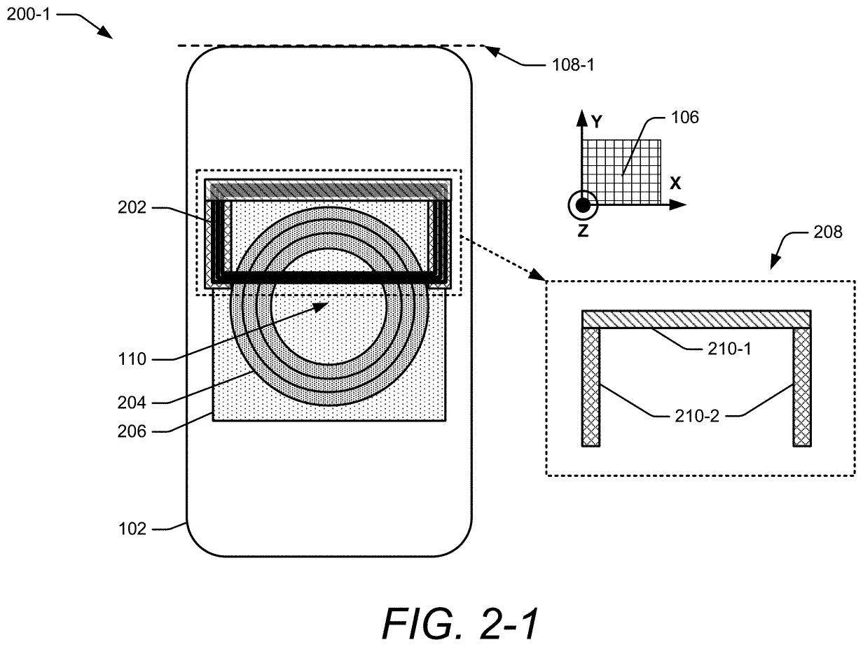

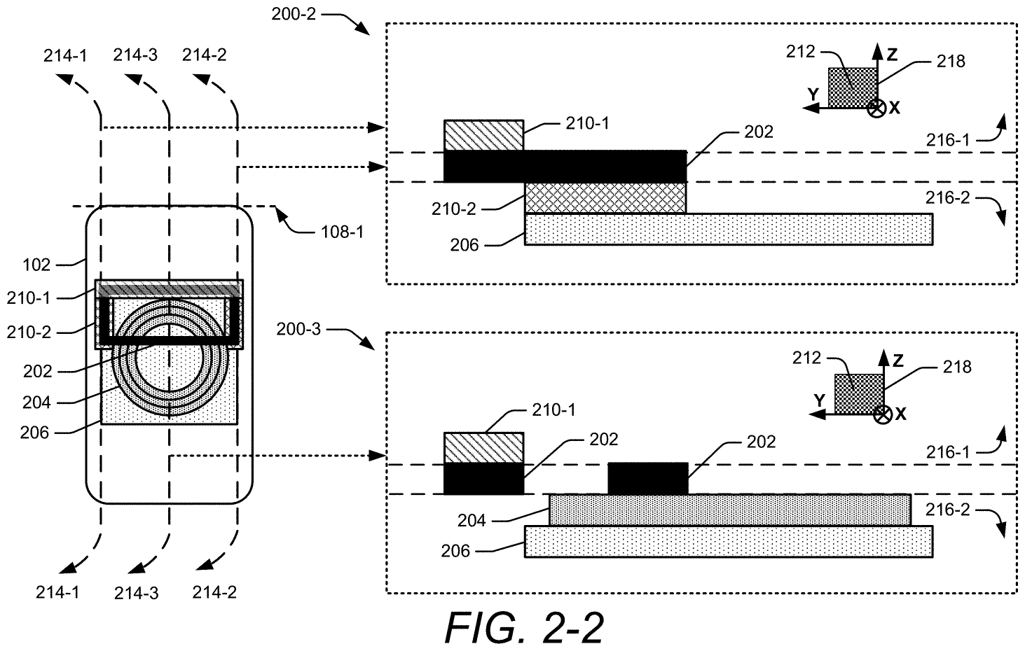

FIG. 2-1 illustrates an example environment 200-1 of a computing device 102 that includes a primary coil 202 configured as an NFC antenna. The primary coil 202 of example environment 200-1 includes windings (e.g., one or more loops) to form a shape that substantially defines the housing plane 106 (e.g., the XY plane). For instance, the primary coil 202 may form a thin, rectangular shape (e.g., a rectangular copper trace on a printed circuit board (PCB)) that is substantially thin in a direction that is normal to housing plane 106 (e.g., the Z-direction) in comparison to the dimensions of the primary coil 202 within the housing plane 106 (e.g., a width along the X-axis, a length along the Y-axis). Though the primary coil 202 described in this disclosure is predominantly referred to as an NFC antenna, the primary coil 202 may also include other types of coils or antennas used for contactless communication (e.g., operating at frequencies outside an NFC antenna range).

The computing device 102 may also include a secondary coil 204 that is positioned further away from the top end 108-1 (e.g., centered about the center region 110) than the primary coil 202. The secondary coil 204 may be configured as a wireless charging coil that enables wireless charging of a battery (not shown) of the computing device 102 from a wireless charger (not shown). The efficiency of the wireless charging using the secondary coil 204 is not diminished (e.g., negatively affected) by the primary coil 202 or the ferrite section 210-1 and 210-2.

The secondary coil 204, unlike the primary coil 202, may act as a parasitic element, which is not driven with current to perform contactless communications between NFC antennas. The secondary coil 204 may be positioned to overlap the primary coil 202 in the direction that is normal to the housing plane 106 and on a second side of the primary coil 202 (opposite a first side). In general, the secondary coil 204 may be positioned on either the first side or the second side of the primary coil 202.

When current (e.g., the current 116) is driven into the primary coil 202, resultant magnetic fields (e.g., magnetic fields 114-2) may induce magnetic fields into the secondary coil 204 through mutual induction, which may increase the magnetic field strength of the NFC antenna structure and improve the inductive coupling to a receiving NFC antenna (e.g., the receiving antenna 120). The secondary coil 204 is predominantly referred to as a WLC coil in this disclosure, but may alternatively include a parasitic element including, for instance, an inductor, a circuit, a coil, or an antenna of the computing device 102 that may be used to improve the inductive coupling to a receiving NFC antenna.

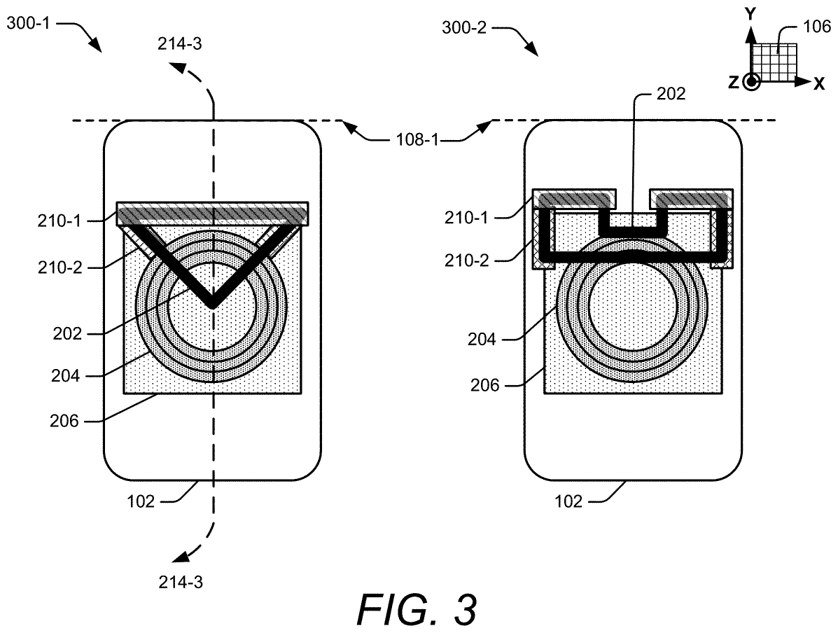

The primary coil 202 and the secondary coil 204 are not limited to the shapes illustrated in example environment 200-1, and additional shapes are described with reference to FIG. 3. Though not depicted in example environment 200-1, the first side of the primary coil 202 (opposite the second side) may be positioned near and/or in contact with a back surface of the computing device 102 (e.g., a back surface of the housing 104). The back surface, for instance, may be opposite a front surface of the computing device 102 that includes a display for rendering media content. As a result, the computing device 102 of example environment 200-1 is depicted from the back surface.

Additionally, the secondary coil 204 may be mounted onto and/or positioned near a nanocrystalline (NC) surface 206 to improve isolation of radiation from the secondary coil 204 and/or the primary coil 202. The NC surface 206 is not limited to the topography of example environment 200-1 and may include various shapes to partially or wholly overlap a surface of the secondary coil 204 and/or partially overlap the second side of the primary coil 202. The NC surface 206 may contain NC materials including polycrystalline materials with crystallite sizes on the order of nanometers (nm).

The computing device 102 may also include a ferrite sheet 208 made of one or more ferrimagnetic materials (e.g., strontium, barium, manganese, nickel, zinc) to increase the magnetic field strength associated with the NFC antenna structure and improve the inductive coupling to a receiving NFC antenna. In general, ferrite sheets may be used to reduce magnetic field loss and improve isolation of magnetic fields from, for instance, generating eddy currents in nearby conductive elements and/or surfaces.

The ferrite sheet 208 of example environment 200-1 is separated into two sections. A first ferrite section 210-1 may be elongated with a longitudinal axis that is substantially aligned in parallel with the top end 108-1 of the computing device 102. The first ferrite section 210-1 may also be positioned to partially overlap the primary coil 202 on the first side, and a second ferrite section 210-2 may be positioned to partially overlap the primary coil 202 on the second side. The first ferrite section 210-1 and the second ferrite section 210-2 shown in example environment 200-1 do not overlap each other in the direction normal to the housing plane 106. The second ferrite section 210-2 may include a first segment and a second segment of similar dimensions. The second ferrite section 210-2 may be similar to or distinct from the first ferrite section 210-1 in terms of a thickness and/or a composition of the ferrimagnetic material.

FIG. 2-2 illustrates example cross-sectional views 200-2 and 200-3 of the NFC antenna structure that depict the ferrite sheet 208 separated into two sections (e.g., the first ferrite section 210-1 and the second ferrite section 210-2). The NFC antenna structure may inclusively refer to a combination of the primary coil 202, the secondary coil 204, the NC surface 206, the first ferrite section 210-1, and the second ferrite section 210-2. Example cross-sectional views 200-2 and 200-3 are depicted with respect to a top plane 212 (e.g., a YZ plane) that is orthogonal to the housing plane 106. The thicknesses of each component (e.g., the primary coil 202, the secondary coil 204, the NC surface 206, the first ferrite section 210-1, and the second ferrite section 210-2) are depicted similarly for ease of display and are not limited to the relative thicknesses shown. Furthermore, the NFC antenna structure is not limited to the arrangements depicted in the cross-sectional views 200-2 and 200-3, which are shown as examples. Due to similarities, the example cross-sectional view 200-2 may be taken at either a first line 214-1 along a first edge of the primary coil 202 or at a second line 214-2 along a second edge of the primary coil 202. The example cross-sectional view 200-3 is taken at a third line 214-3 across the center of the primary coil 202.

In the example cross-sectional view 200-2, the first ferrite section 210-1 may be positioned on the first side 216-1 of the primary coil 202 (opposite the second side 216-2 of the primary coil 202) to partially overlap the primary coil 202 on the first side 216-1. For the example NFC antenna structure of FIG. 2-2, the first ferrite section 210-1 overlaps a width of the primary coil 202 windings (e.g., a distance between an outer perimeter and an inner perimeter of the windings) as shown in example cross-sectional view 200-3.

Though not depicted in example cross-sectional view 200-2, the first ferrite section 210-1 may extend beyond the primary coil 202 (e.g., beyond the outer perimeter of the windings along in the Y-direction) without overlapping the second ferrite section 210-2 in a normal direction 218 (e.g., a direction that is normal to the housing plane 106, in the Z-direction). Though not depicted, the NC surface 206 may extend further than shown (e.g., in the Y-direction), may be eliminated, and/or may be replaced with another isolating material (e.g., a ferrite material). In the example cross-sectional view 200-3, the primary coil 202 may overlap the secondary coil 204 at least partially in the normal direction 218 and may be positioned in contact with or in close proximity to the secondary coil 204 to improve inductive coupling. Any one or more of the primary coil 202, the secondary coil 204, or the NC surface 206 may include a flexible material to allow for one or more bends, curves, or corners. Additional example topographies for NFC antenna structures are described with reference to FIG. 3.

FIG. 3 illustrates example, non-limiting variations 300 of the NFC antenna structure. The variations are not limited to the combinations shown, and any one or more components of the variations shown may be combined to form additional NFC antenna structures (not depicted). In each variation 300, the first ferrite section 210-1 is positioned towards the top end 108-1 of the computing device 102 and arranged not to overlap with the second ferrite section 210-2 in the normal direction 218. In each variation 300, the first ferrite section 210-1 is also positioned on the first side 216-1 of the primary coil 202 while the second ferrite section 210-2 is positioned on the second side 216-2 of the primary coil 202, opposite the first side 216-1.

Example variation 300-1 illustrates the primary coil 202 with a triangular shape. In general, the primary coil 202 and/or the secondary coil 204 are not limited to the shapes depicted in FIGS. 1, 2-1, and 2-2, and may further include shapes such as a square, a circle, a rectangle, an ellipse, a semi-circle, a cylinder, a cube, a rectangular prism, and so forth, and may include one or more bends, corners, or curves. A more-complex shape is depicted in example variation 300-2 in which the primary coil 202 is bent in several locations within the housing plane 106. In example variation 300-2, the first ferrite section 210-1 is also separated into two segments. In general, the first ferrite section 210-1 and/or the second ferrite section 210-2 may be separated into two or more segments to enable the improvement of inductive coupling to a receiving NFC antenna near the top end 108-1 of the computing device 102.

While the second ferrite section 210-2 is depicted as being symmetric about the third line 214-3 in example variations 300-1 and 300-2, in general, the second ferrite section 210-2 may be positioned asymmetrically about the third line 214-3. While not depicted, the NC surface 206 may extend further towards the top end 108-1 of the computing device 102 or utilize a different shape including, but not limited to, a circle, a rectangle, an ellipse, a rounded rectangle, a more complex shape, and so forth.

Though not depicted, the primary coil 202 may be positioned not to overlap the secondary coil 204 in the normal direction 218. Furthermore, for some computing devices 102, a secondary coil 204 (e.g., a WLC coil) may not be available or positioned in close-enough proximity to improve the inductive coupling to a receiving NFC antenna of another device. These computing devices 102, however, may still benefit from positioning the first ferrite section 210-1 towards the top end 108-1 of the computing device 102. Additionally, the second ferrite section 210-2 or the first ferrite section 210-1 may be removed in some NFC antenna structures. The improvements in the inductive coupling and magnetic field strength are further described with respect to FIGS. 4-1 and 4-2.

### Results

FIGS. 4-1 and 4-2 illustrate example implementations 400 (e.g., environment 400-1 and results 400-2 through 400-4) of the NFC antenna structure to increase the magnetic field strength generated by the NFC antenna and improve the inductive coupling to a receiving antenna (e.g., the receiving antenna 120). In environment 400-1, the NFC antenna structure is shown with a Y-axis centered about “X=0 mm” and an X-axis centered about “Y=0 mm.” The example data of FIGS. 4-1 and 4-2 are taken along the third line 214-3 of the Y-axis at “X=0 mm.”

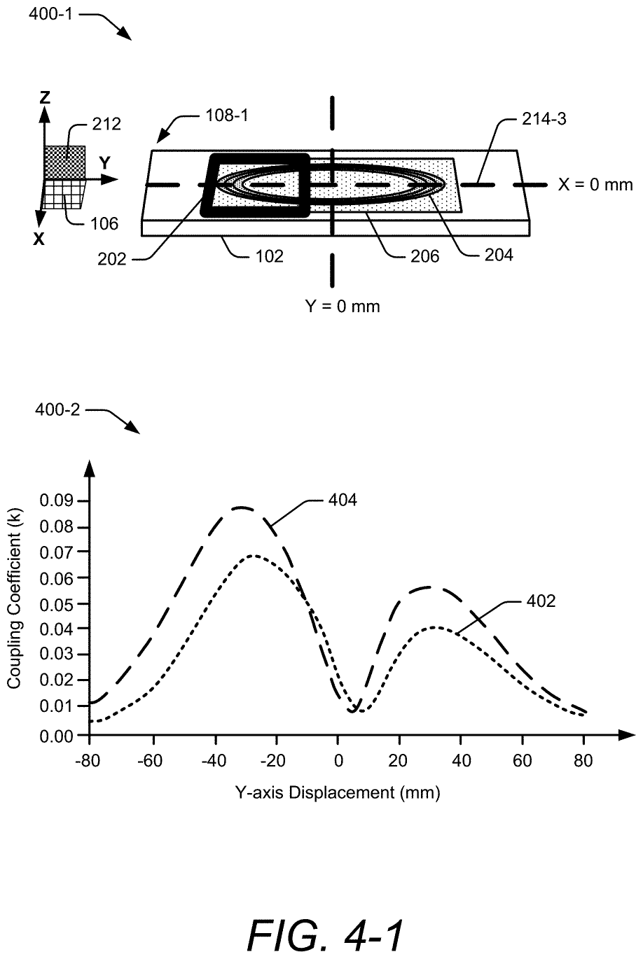

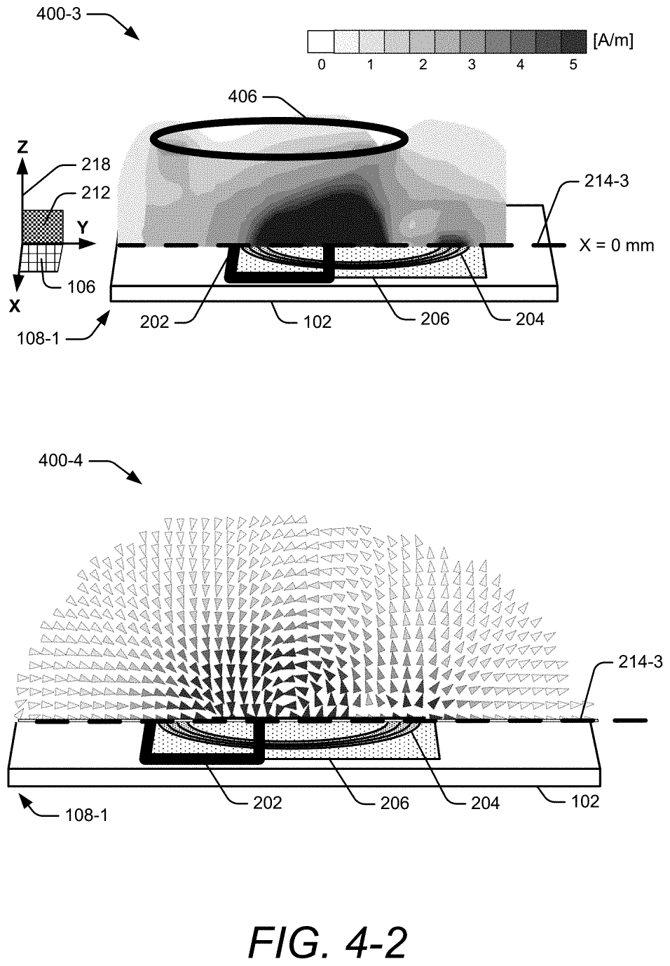

Result 400-2 of FIG. 4-1 illustrates a plot of an example coupling coefficient (k) as a function of displacement from “Y=0 mm.” The coupling coefficient for a conventional NFC antenna structure (plot 402), in which the first ferrite section 210-1 is placed on the second side 216-2 of the primary coil 202 (similar to the second ferrite section 210-2), is shown for reference. The coupling coefficient for the NFC antenna structure of this disclosure (plot 404), as described with respect to FIGS. 2-1 and 2-2, is also shown in 400-2 to illustrate the improvement of the coupling coefficient over the conventional NFC antenna structure (plot 402).

The coupling coefficient (k) is a unit-less term (e.g., ranging in value from 0-1) that refers to a portion of the magnetic field flux, produced by the NFC antenna, which is coupled (e.g., received, induced) into a receiving antenna (e.g., the receiving antenna 120). For a case in which all of the magnetic field flux is coupled into the receiving antenna, the coupling coefficient may be unity (e.g., a value of one). Whereas, for a case in which none of the magnetic field flux is coupled into the receiving antenna, the coupling coefficient may have a value of zero. In result 400-2, the coupling coefficient for plot 404 has increased closer to unity with respect to plot 402. Additionally, the coupling coefficient has increased in a direction towards the top end 108-1 of the computing device 102 to enable a more-efficient performance of the contactless communication.

FIG. 4-2 illustrates two-dimensional maps of the magnetic-field strength (H), measured in units of Amperes (A) per meter (m). Result 400-3 depicts the magnetic-field strength in relation to an example receiving antenna 406 (e.g., of a receiving device) positioned near the NFC antenna structure. In particular, the ferrite sheet 208 described in FIGS. 2-1 and 2-2 enables strong magnetic fields to form near the example receiving antenna 406.

Result 400-4 depicts the corresponding vector components of the magnetic field strength. In particular, some normal vector components (e.g., components of the magnetic field orthogonal to the housing plane 106 and parallel to the normal direction 218) are positioned towards the top end 108-1 of the computing device 102 to increase the inductive coupling to a receiving antenna (e.g., the example receiving antenna 406) at the top end 108-1. These results 400-2 through 400-4 indicate that the NFC antenna structure described in this disclosure enables increased radiation near the top end 108-1 of a computing device 102 with greater inductive coupling to a receiving NFC antenna of another device. As a result, this NFC antenna structure may improve contactless communication between devices.

### CONCLUSION

Although an NFC antenna structure for radiation enhancement of a computing device has been described in language specific to features, it is to be understood that the subject of the appended claims is not necessarily limited to the specific techniques described herein. Rather, the specific techniques are disclosed as example implementations of an NFC antenna structure for radiation enhancement of a computing device.

1. A computing device comprising:
a housing that substantially defines a housing plane, the housing comprising a top end defining a top plane perpendicular to the housing plane, the top end opposite a bottom end defining a bottom plane parallel to the top plane;
a primary coil comprising windings forming a first shape that is positioned substantially parallel to the housing plane and at least partially within the housing, the first shape comprising a first side aligned parallel to the housing plane, the first side opposite a second side, the primary coil usable to generate a magnetic field when subject to an electric current;
a secondary coil comprising windings forming a second shape that is positioned substantially parallel to the housing plane and at least partially within the housing, the secondary coil at least partially overlapping the primary coil in a direction that is normal to the housing plane on the second side to enable a portion of the magnetic field generated by the primary coil to be induced into the secondary coil through mutual induction when the primary coil is subject to the electric current; and
a ferrite sheet configured to increase a strength of the magnetic field, the ferrite sheet separated into:
a first ferrite section positioned towards the top plane of the top end and at least partially within the housing, the first ferrite section at least partially overlapping the primary coil in the direction that is normal to the housing plane, the first ferrite section configured to overlap a first portion of the primary coil on the first side; and
a second ferrite section, separate from the first ferrite section, positioned not to overlap with the first ferrite section and not to overlap with the secondary coil with respect to the direction that is normal to the housing plane, the second ferrite section configured to overlap a second portion of the primary coil on the second side.

2. The computing device as recited by claim 1, wherein the primary coil is configured as a near-field communication, NFC, antenna to enable operations of a contactless communication system.

3. The computing device as recited by claim 2, wherein another portion of the magnetic field generated by the primary coil is usable to induce a current into a recipient antenna of a second computing device through inductive coupling.

4. The computing device as recited by claim 3, wherein the ferrite sheet is further configured to increase, at the top end of the computing device, the inductive coupling to the recipient antenna of the second computing device.

5. The computing device as recited by claim 1, wherein the ferrite sheet is further configured to increase the strength of the magnetic field towards the top end of the computing device when the primary coil is subject to the electric current.

6. The computing device as recited by claim 1, wherein the secondary coil is configured as a wireless charging coil that enables operations of wireless charging of a battery of the computing device.

7. The computing device as recited by claim 1, wherein the ferrite sheet is further configured to at least partially shield circuitry of the computing device from the magnetic field generated.

8. The computing device as recited by claim 1, wherein:
the secondary coil is mounted onto a nanocrystalline surface, the nanocrystalline surface comprising a flexible nanocrystalline material; and
the primary coil is positioned to at least partially overlap the nanocrystalline surface with respect to the direction that is normal to the housing plane.

9. The computing device as recited by claim 1, wherein:
the primary coil comprises a flexible conductive material to enable the primary coil to bend; and
the secondary coil comprises another flexible conductive material to enable the secondary coil to bend.

10. The computing device as recited by claim 1, wherein the computing device is configured as a mobile electronic device.
